(19) United States
(12) Patent Application Publication
(10) Pub. No.: US 2024/0238788 A1
(43) Pub. Date: Jul. 18, 2024

(54) FLUID DEVICE, DETECTION KIT, AND METHOD FOR DETECTING TARGET SUBSTANCE

(71) Applicant: TOPPAN Holdings Inc., Tokyo (JP)

(72) Inventors: Yuta SUZUKI, Tokyo (JP); Keisuke GOTO, Tokyo (JP)

(73) Assignee: TOPPAN Holdings Inc., Tokyo (JP)

(21) Appl. No.: 18/411,958

(22) Filed: Jan. 12, 2024

(30) Foreign Application Priority Data
Jan. 18, 2023 (JP) 2023-005941

(51) Int. Cl. B01L 3/00; G01N 21/64

(52) U.S. Cl. CPC B01L 3/50853; G01N 21/6428; B01L 2200/026; B01L 2200/0689; B01L 2200/16; B01L 2300/041; B01L 2300/1805; G01N 2021/6439

(57) ABSTRACT

A fluid device includes a substrate having a plurality of wells on one surface; and a first lid disposed to face the well of the substrate, in which the first lid has an inlet that penetrates the first lid in a thickness direction, an injection tube that communicates with the inlet and extends above the inlet, an outlet that penetrates the first lid in a thickness direction, a discharge tube that communicates with the outlet and extends above the outlet, and an annular wall portion in a plan view provided along a peripheral edge portion of an upper surface of the first lid, and an upper end of the wall portion is higher than upper ends of the injection tube and the discharge tube.

### BACKGROUND OF THE INVENTION

### Field of the Invention

The present invention relates to a fluid device, a detection kit, and a method for detecting a target substance.

Priority is claimed on Japanese Patent Application No. 2023-005941, Jan. 18, 2023, the entire content of which is incorporated herein by reference.

### Description of the Related Art

A technology of detecting a biomolecule in a fluid device is known. For example, in a DNA microarray technology, there is a case where a biomolecule is detected by introducing the biomolecule into a micropore and carrying out reaction with heating.

In addition, there is known a technology capable of detecting a biomolecule as a single molecule. Examples of such a technology include digital measurement technologies such as digital Enzyme-Linked ImmunoSorbent Assay (ELISA), digital Polymerase Chain Reaction (PCR), digital Invasive Cleavaged Assay (ICA), and the like which are disclosed in Non-Patent Document 1.

As disclosed by Japanese Patent No. 6183471, the inventors previously developed a digital measurement technology using a reaction container (also referred to as a fluid device) having a plurality of wells. In the previously developed method, first, an aqueous medium containing a target substance is fed into a flow channel of the fluid device, and a plurality of wells provided within a flow channel is filled with the aqueous medium. Subsequently, an oily sealing liquid is fed into the flow channel to seal the aqueous medium in the plurality of wells with the oily sealing liquid. By doing this, each well becomes a plurality of independent reaction spaces. In addition, a reaction solution is heated by heating the fluid device, and subjected to detection reaction to carry out detection of a target substance.

### SUMMARY OF THE INVENTION

In the method disclosed by Japanese Patent No. 6183471, there is a case where luminescence is used for the detection reaction. In a case of carrying out detection of a small amount of a target substance, even if the amount is small, when noise luminescence is mixed, detection accuracy tends to decrease, and improvement has been required.

The present invention has been made in view of such circumstances, and an object of the present invention is to provide a fluid device and a detection kit capable of improving detection accuracy. In addition, another object of the present invention is to provide a method for detecting a target substance capable of suppressing generation of noise to realize high detection accuracy.

In order to achieve the above object, an aspect of the present invention includes the following embodiments.

[1] A fluid device including: a substrate including a plurality of wells on one surface; and a first lid being disposed to face the wells of the substrate, in which the first lid has an inlet that penetrates the first lid in a thickness direction, an injection tube that communicates with the inlet and extends above the inlet, an outlet that penetrates the first lid in the thickness direction, a discharge tube that communicates with the outlet and extends above the outlet, and an annular wall portion in a plan view provided along a peripheral edge portion of an upper surface of the first lid, and an upper end of the annular wall portion is higher than upper ends of the injection tube and the discharge tube.

[2] The fluid device according to [1], in which the first lid includes a lid main body facing the wells, and a wall main body being detachable from the lid main body and configured to form the wall portion by being fitted into the lid main body.

[3] The fluid device according to [2], in which the wall main body includes a guide portion overlapping the injection tube in the plan view, and the guide portion includes a guide hole overlapping the inlet in the plan view.

[4] The fluid device according to [1], further including a second lid that is configured to be fitted into the wall portion and airtightly closes the upper end of the wall portion.

[5] A detection kit including: the fluid device according to any one of [1] to [4]; and an oily sealing liquid with a higher density than water.

[6] A method for detecting a target substance using the fluid device according to any one of [1] to [4], the method including: preparing a mixed aqueous solution of a detection reagent that reacts with the target substance and a sample including the target substance; introducing the mixed aqueous solution into an inside the fluid device from the inlet and filling the wells with the mixed aqueous solution; introducing an oily sealing liquid into the fluid device, discharging a portion of the mixed aqueous solution in the inside of the fluid device from the outlet, and sealing the mixed aqueous solution in the wells by the oil sealing liquid; heating the fluid device to react the target substance and the detection reagent; and detecting the target substance, in which the sealing liquid has a higher density than water, and in the sealing, the oil sealing liquid is introduced into the fluid device with a liquid amount at which a liquid surface of the mixed aqueous solution discharged into a space surrounded by the first lid and the wall portion is higher than the upper ends of the injection tube and the discharge tube, and a liquid surface of the oil sealing liquid discharged into the space surrounded by the first lid and the wall portion is lower than the upper ends of the injection tube and the discharge tube.

According to the present invention, it is possible to provide a fluid device and a detection kit capable of improving detection accuracy. In addition, it is possible to provide a method for detecting a target substance capable of suppressing generation of noise to realize high detection accuracy.

### BRIEF DESCRIPTION OF THE DRAWINGS

FIG. 1 is a schematic perspective view illustrating a fluid device and a detection kit of the present embodiment.

FIG. 2 is a cross-sectional view of a fluid device included in the fluid device.

FIG. 3 is an explanatory view of a method for detecting a target substance of the present embodiment.

FIG. 4 is an explanatory view of a method for detecting a target substance of the present embodiment.

FIG. 5 is an explanatory view of a method for detecting a target substance of the present embodiment.

FIG. 6 is a schematic view illustrating an example of an ICA method.

### DETAILED DESCRIPTION OF THE INVENTION

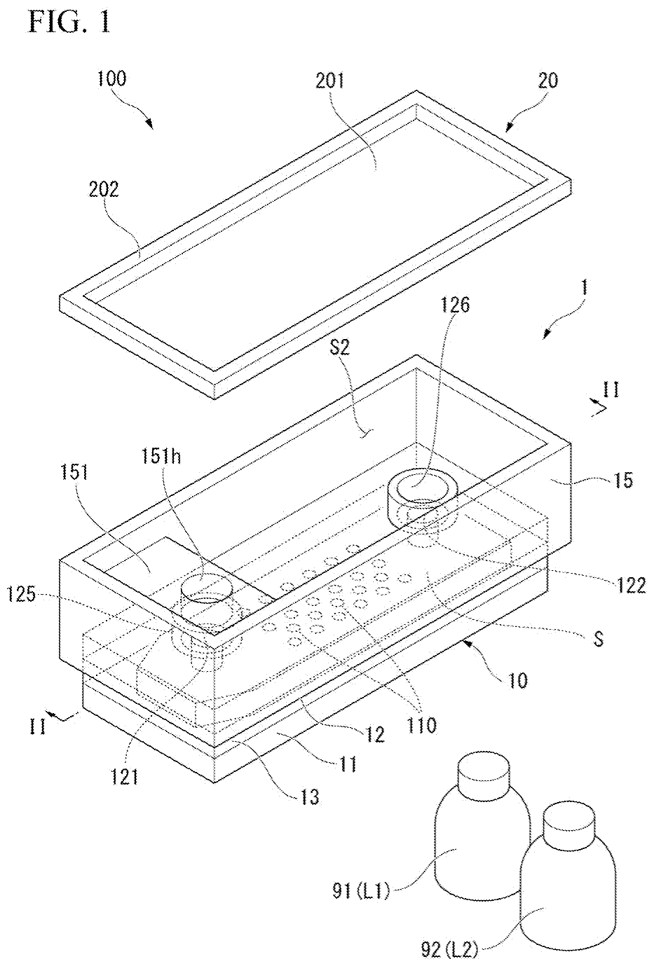

Hereinafter, a fluid device, a detection kit, and a method for detecting a sample according to the present embodiment will be described with reference to FIGS. 1 to 6. In all the following drawings, dimensions, proportions, and the like of each constituent element have been appropriately changed in order to make the drawings easier to see.

### <<Fluid Device, Detection Kit, and Method for Detecting Target Substance>>

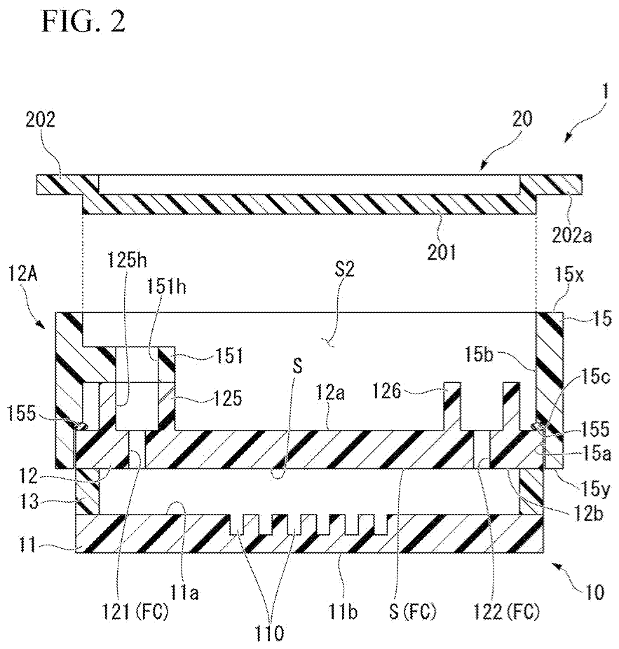

FIG. 1 is a schematic perspective view illustrating a fluid device and a detection kit of the present embodiment. FIG. 2 is a cross-sectional view of the fluid device included in the fluid device, and is a cross-sectional view taken along the line II-II of FIG. 1.

A detection kit 100 includes a fluid device 1, a detection reagent L1, and an oily sealing liquid L2. Each of the detection reagent L1 and the sealing liquid L2 is stored in, for example, each of storage containers 91 and 92. The detection kit 100 is used for detecting a target substance included in a liquid sample.

The sample is an aqueous solution containing a target substance. The sample may include a biological sample and an environmental sample. The biological sample is not particularly limited and may include serum, plasma, urine, a cell culture solution, and the like. In addition, the sample may be a PCR reaction solution and the like including a biological sample as a template and a dyeing reagent as a detection reagent. In addition, examples of the environmental sample may include river water, industrial wastewater, and the like.

Examples of the target substance may include DNA, RNA, protein, virus, cell, exosome, and the like. Here, examples of RNA may include miRNA, mRNA, and the like. In addition, examples of the cell may include bacteria, yeast, animal cells, plant cells, insect cells, and the like.

In the fluid device 1, the detection kit 100 reacts the target substance included in the above-described sample with the detection reagent L1 to detect a target substance. At this time, in the detection kit 100, the sealing liquid L2 is used to form a reaction field suitable for the reaction between the target substance and the detection reagent L1, thereby facilitating detection of the target substance.

A description will be given below in order.

### <Fluid Device>

As shown in FIGS. 1 and 2, the fluid device 1 includes a device main body 10, an adapter 15, and a lid 20. A lid main body 12 described below and the adapter 15 included in the device main body 10 constitute a “lid member” in the present specification. In addition, the adapter 15 corresponds to the “wall main body” in the present specification. The lid member is also referred to as a first lid. The lid 20 is also referred to as a second lid.

### [Device Main Body]

The device main body 10 has a well plate 11, a lid main body 12, and a wall member 13. The device main body 10 is used as a reaction container that accommodates a sample in an internal space S and carries out a detection reaction of a target substance included in the sample. The well plate 11 corresponds to a “substrate” of the present invention.

### (Well Plate)

The well plate 11 is a plate-like member having a rectangular shape or a strip shape in a plan view. The term “plan view” refers to a visual field of an upper surface 11a of the well plate from a vertical direction. On the upper surface 11a of the well plate 11, a plurality of wells 110, which are also referred to as micro-wells 110 is provided at a center of the well plate 11 in a longitudinal direction.

The micro-wells 110 are recesses provided on the upper surface 11a of the well plate 11 and are open on the upper surface 11a. The micro-well 110 refers to a space surrounded by the recess and an imaginary plane parallel to the upper surface 11a and in contact with the upper surface 11a.

The micro-well 110 accommodates a sample accommodated in the internal space S therein and functions as a reaction field between a target substance included in the sample and the detection reagent L1.

A material of the well plate 11 is preferably hydrophobic. Specifically, it is preferable that the material constituting the upper surface 11a of the well plate 11 has a contact angle with the sealing liquid L2 of 5° or greater and 80° or less. When the well plate 11 is formed with such a material, the contact angle between the upper surface 11a and the sealing liquid L2 is 5° or greater and 80° or less. When the contact angle of the upper surface 11a is within the range, the sample tends to be easily isolated in the micro-well 110 in a case where the sealing liquid is introduced into the internal space S by the method described below.

In addition, the contact angle is determined by measurement using the sealing liquid L2 instead of water according to an intravenous drip method defined in JIS R3257-1999.

The material of the well plate 11 may or may not have electromagnetic wave transmittance. Here, examples of electromagnetic wave for which the transmittance is to be determined include X-rays, ultraviolet rays, visible light rays, infrared rays, and the like. In a case where the well plate 11 has electromagnetic wave transmittance, it is possible to use electromagnetic wave to analyze experimental results carried out in the device main body 10 having the well plate 11. For example, fluorescence, phosphorescence, and the like generated as a result of irradiating with an electromagnetic wave can be measured from the well plate 11 side. In addition, the term “electromagnetic wave transmittance” means a property capable of transmitting electromagnetic waves having various wavelengths, such as radio waves, light, X-rays, and gamma rays.

As will be described later in detail, for example, in a case where sample detection is carried out by generating fluorescence having a peak in a wavelength range of 400 to 700 nm, which is a visible light region, in the micro-well 110, a material having favorable transmittance with respect to light at least in the visible light region may be used.

Examples of the material having electromagnetic wave transmittance include glass, resin, and the like. Examples of the resin include an ABS resin, polycarbonate, a cycloolefin copolymer (COC), a cycloolefin polymer (COP), an acrylic resin, polyvinyl chloride, polystyrene, polyethylene, polypropylene, polyvinyl acetate, polyethylene terephthalate (PET), and polyethylene naphthalate (PEN), and the like. These resins may contain various additives, or may be polymer alloys in which a plurality of resins is mixed.

It is preferable that the material having electromagnetic wave transmittance substantially has no autofluorescence. Substantially has no autofluorescence means that the material has no autofluorescence of a wavelength used for sample detection at all, or even when the material has autofluorescence, the autofluorescence is so weak as not to affect the sample detection. For example, when the autofluorescence is about ½ or less, or 1/10 or less compared to fluorescence of a detection subject, it can be said that the autofluorescence is so weak as not to affect the sample detection. When the well plate 11 is formed using such a material, it is possible to increase detection sensitivity in the sample detection using electromagnetic waves.

Examples of the material having electromagnetic wave transmittance and not emitting autofluorescence include quartz glass and the like. Examples of a material which has weak autofluorescence and does not interfere with sample detection using electromagnetic waves include low fluorescence glass, an acrylic resin, a cycloolefin copolymer (COC), a cycloolefin polymer (COP), cast polypropylene (CPP), and the like.

A thickness of the well plate 11 can be appropriately determined. In a case where the fluorescence is observed from the well plate 11 side using a fluorescence microscope, the thickness of the well plate 11 may be, for example, 5 mm or less, 2 mm or less, or 1.6 mm or less.

The well plate 11 may have a single-layer configuration using only the materials described above, or may be a laminate of a plurality of materials. In a case where the laminate is processed to form the well plate 11, a layer having the micro-wells 110 and a layer supporting the layer may be made of different materials. In such a case, the material of the layer having the micro-wells 110 is preferably hydrophilic (the contact angle with water is 70° or more and 180° or less) that is easily wet by water.

### (Micro-Well)

As a shape of the micro-well 110, various shapes can be adopted. Examples of the shape of the micro-well 110 include a tubular shape such as a cylindrical shape, an elliptical tubular shape, and a polygonal tubular shape, a weight shape such as a conical shape and a pyramid shape, a trapezoidal shape such as a truncated cone shape and a truncated pyramid shape, and the like. In a case where the micro-well 110 has a weight shape or a trapezoidal shape, the shape may be a shape in which an opening diameter gradually decreases in a depth direction of the well.

A bottom portion of the micro-well 110 may be flat, or may have a curved surface such as a convex surface and a concave surface.

In a case where the shape of the micro-well 110 is a circular shape in a plan view, a diameter, namely opening diameter, of the opening portion of the micro-well 110 is, for example, preferably 10 nm to 100 μm, more preferably 100 nm to 50 μm, and further more preferably 1 μm to 20 μm. In addition, a depth of the micro-well 110 is, for example, preferably 10 nm to 100 μm, more preferably 100 nm to 50 μm, and further more preferably 1 μm to 20 μm.

A capacity of the micro-well 110 is, for example, preferably 1 fL or more and 6 nL or less, more preferably 1 fL or more and 5 pL or less, further more preferably 1 fL or more and 2 pL or less, and particularly preferably 1 fL or more and 300 fL or less. When the capacity of one micro-well 110 is in such a range, it is possible to suitably carry out an enzymatic reaction carried out in a micro-space such as digital PCR and an invader reaction. It is possible to carry out gene mutation detection and the like, for example, by the digital PCR.

The volume of the micro-well 110 can be calculated by measuring a dimension of the micro-well 110 using a scanning electron microscope or a phase contrast microscope.

The well plate 11 has a plurality of the micro-wells 110 of the same shape and the same size. The same shape and the same size may be the same shape and the same capacity to an extent required for carrying out digital measurement, and variations to an extent of manufacturing error are allowed.

A density of the micro-wells 110 is, for example, 100,000 to 10,000,000 pieces/cm², preferably 100,000 to 5,000,000 pieces/cm², and more preferably 100,000 to 1,000,000 pieces/cm². When the density of the micro-wells 110 is within such a range, it is easy to carry out operation of encapsulating a sample in a predetermined number of the micro-wells 110. In addition, it is also easy to observe the wells for analyzing experimental results.

### (Lid Main Body)

The lid main body 12 has the same contour shape, namely strip shape, as that of the well plate 11 in a plan view. The lid main body 12 is disposed to face the upper surface 11a of the well plate 11 with a gap therebetween.

The lid main body 12 has two through holes penetrating in a thickness direction. Each of the two through holes is provided on one end side and the other end side of the lid main body 12 in a longitudinal direction. One through hole is an inlet 121 used when injecting a liquid material into the internal space S of the device main body 10. The other through hole is an outlet 122 used when discharging the liquid material from the internal space S.

Here, the term “liquid material” corresponds to not only a liquid sample but also a detection reagent or a sealing liquid.

The inlet 121, the internal space S, and the outlet 122 communicate with each other in this order, and as a whole form a flow channel FC. In the device main body 10, a liquid material is caused to appropriately flow to the flow channel FC to carry out a detection reaction of a target substance. In a plan view, the plurality of micro-wells 110 is disposed between the inlet 121 and the outlet 122.

A tubular injection port 125, which is also referred to as injection tube 125 that surrounds a periphery of the inlet 121 is provided on an upper surface 12a of the lid main body 12. The injection port 125 extends above the inlet 121 and communicates with the inlet 121. The injection port 125 is, for example, used for connection of a syringe when the internal space is filled with a liquid material by using the syringe filled with the liquid material.

Similarly, a tubular discharge port 126, which is also referred to as discharge tube 126 that surrounds a periphery of the outlet 122 is provided on the upper surface 12a of the lid main body 12. The discharge port 126 extends above the outlet 122 and communicates with the outlet 122. The discharge port 126 is, for example, used for connection of a tube through which a liquid material flows when the liquid material is extracted from the internal space S.

As the material of the lid main body 12, a material exemplified as the material of the well plate 11 described above can be adopted. The material of the lid main body 12 may be the same as or different from the material of the well plate 11.

In addition, the material of the lid main body 12 may or may not have electromagnetic wave transmittance.

In a case where the micro-wells 110 are observed in a bright field, at least one of the well plate 11 and the lid main body 12 has light transmittance.

The material of the lid main body 12 is preferably hydrophobic. Specifically, it is preferable that the material constituting a surface 12b of the lid main body 12 facing the internal space S, which is also referred to as a lower surface 12b has a contact angle with the sealing liquid L2 of 5° or greater and 80° or less. When the lid main body 12 is formed with such a material, the contact angle between the lower surface 12b and the sealing liquid L2 is 5° or greater and 80° or less. When the contact angle of the lower surface 12b is within the above range, in a case where a sealing liquid is introduced into the internal space S by a method to be described later, a sample tends to be easily isolated in the micro-well 110.

### (Wall Member)

A wall member 13 is formed in a closed annular shape in a plan view. The wall member 13 is disposed along an outer edge of the upper surface 11a of the well plate 11. In FIG. 1, a wall surface of the wall member 13 facing the internal space S is substantially rectangular in a plan view, and a width thereof gradually decreases on the inlet 121 side. In other words, a dimension of the wall surface of the wall member 13 facing the internal space S on the inlet 121 side in a short direction of the well plate 11 in a plan view is smaller than a dimension of the wall surface of the wall member 13 facing the internal space S on the outlet 122 side in a short direction of the well plate 11 in a plan view.

The wall member 13 is sandwiched between the well plate 11 and the lid main body 12, and integrated with each other to form the device main body 10. A space surrounded by the well plate 11, the lid main body 12, and the wall member 13 is an internal space S in which a liquid sample is accommodated. The internal space S extends in a longitudinal direction of the well plate 11 along a strip-like well plate 11.

The wall member 13 functions as a wall surface of the internal space S and also functions as a spacer between the well plate 11 and the lid main body 12. A height of the wall member 13, that is, a height of the internal space S may be, for example, 100 μm or less.

A material of the wall member 13 is not particularly limited, and for example, it is possible to suitably use a double-sided adhesive tape in which an acrylic-based adhesive is laminated on both sides of a core material film. Examples of the material of the core material film include a silicone rubber and an acrylic foam. By forming the wall member 13 using such a material, the internal space S can be liquid-tightly formed.

In addition, as the material of the wall member 13, the same material as the above-described well plate 11 can be adopted. The wall member 13 formed of such a material can be integrated with the well plate 11 and the lid main body 12 by adhesion with an adhesive, or by welding by heat welding, ultrasonic welding, laser welding, or the like.

In addition, the wall member 13 may be formed integrally with the well plate 11 and may constitute a part of the well plate 11. Similarly, the wall member 13 may be formed integrally with the lid main body 12 and may constitute a part of the lid main body 12.

The above-described well plate 11 can be manufactured using known injection molding, micro-imprinting technology, or nanoimprinting technology. In addition, the well plate 11 can be manufactured by forming the micro-wells 110 by etching using a known photolithography technology.

The above-described lid main body 12 can be manufactured by known injection molding, photo fabrication, and cutting, or by appropriately combining these methods.

In a case where the wall member 13 is formed integrally with the lid main body 12, the wall member 13 can be manufactured simultaneously with the lid main body 12 by known injection molding. In a case where the wall member 13 is separate from the lid main body 12, the wall member 13 can be manufactured by cutting out a double-sided adhesive tape in which an acrylic-based adhesive is laminated on both sides of the above-described core material film.

### [Adapter]

An adapter 15, which is also referred to as wall main body 15, is fitted into the lid main body 12 from above, and constitutes the lid member 12A together with the lid main body 12. The adapter 15 is detachable from the lid main body. The adapter 15 is a member having an annular shape in a plan view, and is fitted into the lid main body 12 to constitute a wall portion provided along a peripheral edge portion of the upper surface 12a of the lid main body 12. That is, the lid member 12A has the wall portion provided along the peripheral edge portion of the upper surface 12a.

In a fluid device 1, a bottom surface of the device main body 10, namely a lower surface 11b of the well plate 11, is exposed to the outside. In addition, in the fluid device 1, a lower end 15y of the adapter 15 is positioned above a lower end of the device main body 10 in a state in which the adapter 15 is fitted into the lid main body 12 of the device main body 10. Therefore, for example, in a detection method described later, when the fluid device 1 is heated on a heater, the bottom surface of the device main body 10 is in direct contact with a heater surface, and heating is facilitated.

The lid member 12A has a space S2 surrounded by the lid main body 12 and the adapter 15. As will be described later, the space S2 functions as a storage portion that stores waste liquid in detection operation of the target substance. In the lid member 12A, an upper end of the wall portion of the lid member 12A, that is, an upper end 15x of the adapter 15 is higher than the upper ends of the injection port 125 and the discharge port 126.

On an inner periphery of the adapter 15, a first surface 15a covering a side surface of the lid main body 12, a second surface 15b with a diameter smaller than that of the first surface 15a, and a third surface 15c connecting the first surface 15a and the second surface 15b are provided. When the adapter 15 is fitted into the lid main body 12, a packing 155 is disposed between the third surface 15c and the upper surface 12a of the lid main body 12. As a result, liquid leakage from an interface between the device main body 10 and the adapter 15 can be suppressed.

In addition, on the inner periphery of the adapter 15, a guide portion 151 that overlaps the injection port 125 in a plan view is provided. The guide portion 151 has a guide hole 151h that overlaps the inlet 121 in a plan view.

As the material of the adapter 15, the materials exemplified as the material of the above-described well plate 11 can be adopted. The material of the adapter 15 may be the same as or different from the material of the lid main body 12. In a case where the material of the adapter 15 is the same as the material of the well plate 11 and the lid main body 12, when the fluid device 1 is heated in a detection reaction described later, distortion between members is unlikely to occur due to a change in volume caused by a temperature change, which is preferable.

In a case where an anti-slip layer made of, for example, silicone rubber, synthetic rubber, and the like is formed on the first surface 15a of the adapter 15, the anti-slip layer functions as an anti-slip of the adapter 15 when the adapter 15 is fitted into the device main body 10, and the adapter 15 is unlikely to be pulled off, which is preferable.

In addition, the material of the adapter 15 may or may not have electromagnetic wave transmittance.

The adapter 15 can be manufactured by known injection molding, photo fabrication, and cutting, or by appropriately combining these methods. A thickness thereof may be appropriately adjusted in order to suppress deformation or distortion during manufacturing.

### [Lid]

A lid 20 is fitted into the wall portion, namely the adapter 15, of the lid member 12A and airtightly closes an upper end side of the wall portion. The lid 20 has a main body 201 and a flange 22 provided in a peripheral edge portion of the main body 201.

The lid 20 has a configuration in which the main body 201 is fitted into the second surface 15b of the adapter 15 and a lower surface 202a of the flange 202 comes into contact with the upper end 15x of the adapter 15, and thereby the upper end side of the wall portion of the lid member 12A is closed.

### [Detection Reagent]

The detection reagent L1 reacts with a target substance and is used for detecting the target substance. Examples of the detection reagent L1 include a buffer substance, an enzyme, a substrate, an antibody, an antibody fragment, and the like.

For example, in a case where the target substance is a nucleic acid, the enzyme is selected according to contents of biochemical reaction in order to carry out the biochemical reaction such as an enzymatic reaction against a template nucleic acid related to the target substance. The biochemical reaction against the template nucleic acid is, for example, a reaction in which signal amplification occurs under conditions in which the template nucleic acid is present.

The detection reagent L1 is selected according to the detection reaction to be adopted. Specific examples of the detection reaction include an ICA method, a loop-mediated isothermal amplification (LAMP) method (registered trademark), a 5′→3′ nuclease method (TaqMan (registered trademark) method), a fluorescent probe method, and the like.

### [Sealing Liquid]

A sealing liquid L2 is oily and has a higher density than water. In the present specification, the density of a liquid is a value measured at 25° C. by a known method.

A density of the sealing liquid L2 may be 1.1 g/cm³ or greater, 1.3 g/cm³ or greater, or 1.5 g/cm³ or greater. Upper limit of the density of the sealing liquid L2 is not particularly limited but may be 2.0 g/cm³.

In addition, it is preferable that the sealing liquid L2 is immiscible or difficult to be miscible with the sample which is an aqueous liquid. The sealing liquid L2 covers an opening portion of the micro-well 110 accommodating a mixed aqueous solution of a sample and a detection reagent L1 therein and has a function of individually sealing such that the mixed aqueous solutions accommodated inside the micro-well 110 are not mixed with each other.

The sealing liquid L2 is preferably oil. As the oil, fluorine-based oil, silicone-based oil, hydrocarbon-based oil, a mixture thereof, and the like can be used. Specific examples of the sealing liquid include fluorine-based liquid such as FC-40, FC-43, FC-770, FC-72, FC-3283 (all manufactured by 3M), and the like.

In addition, as the sealing liquid L2, mineral oil and the like used for a PCR reaction and the like can also be used.

### <Method for Detecting Sample>

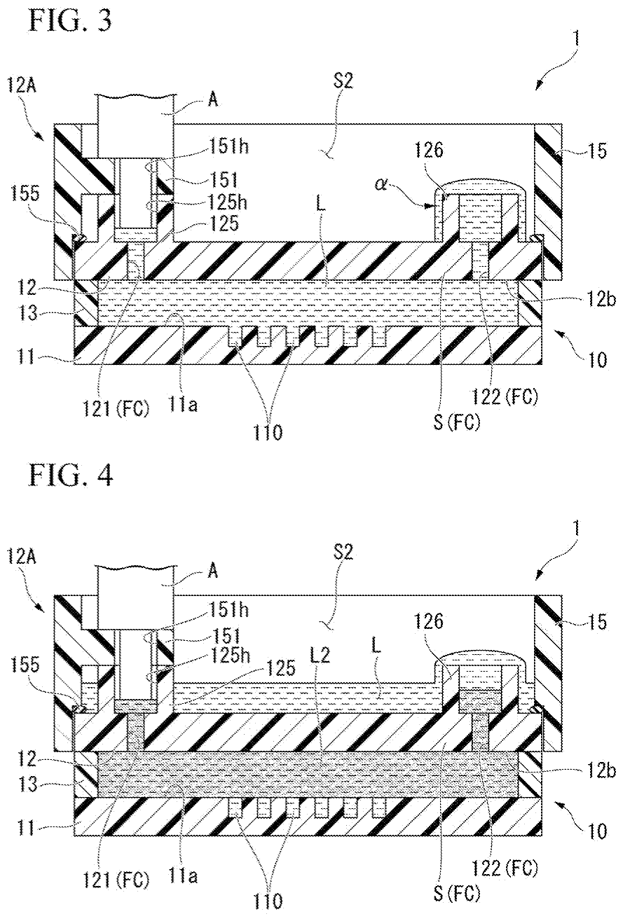

FIGS. 3 to 6 are explanatory views for a method for detecting a target substance of the present embodiment. A method for detecting a target substance is carried out using the fluid device 1 of the present embodiment, and includes:
(1) preparing a mixed aqueous solution of a detection reagent L1 that reacts with a target substance and a sample;
(2) introducing a mixed aqueous solution into an inside of the device main body 10 of a fluid device 1, namely the internal space Sand filling a micro-well 110 with the mixed aqueous solution, using the above-described fluid device 1;
(3) introducing an oily sealing liquid L2 into the device main body 10, discharging the mixed aqueous solution in the internal space S from a discharge port 126, and sealing the micro-well 110 with the mixed aqueous solution using the sealing liquid L2;
(4) heating the device main body 10 to react the target substance and the detection reagent L1; and
(5) detecting reagent L1 to detect the target substance.

In the following description, a method for detecting a target substance is carried out using the above-described fluid device 1. FIGS. 3 to 5 are shown omitting the lid 20.

### (1) Preparing Mixed Aqueous Solution

First, the liquid sample and the detection reagent L1 are mixed to prepare a mixed aqueous solution. A concentration of the detection reagent L1 in the mixed aqueous solution is appropriately adjusted depending on the type of the detection reagent L1 to be used and the type of detection reaction.

The detection reagent L1 to be used may contain an adsorption inhibitor. The adsorption inhibitor has a function of suppressing the adsorption of the target substance, enzyme, or the like contained in the mixed aqueous solution to the member of the fluid device 1. Examples of the adsorption inhibitor may include a surfactant and protein.

In order to facilitate detection of the target substance, the sample may be pre-treated prior to the adjustment of the mixed aqueous solution. Examples of the pre-treatment include concentration adjustment (for example, dilution and concentrating), supporting by a carrier, binding reaction of two or more kinds of target substances, filtration sterilization by filtering, pH adjustment, denaturation, which is also referred to as annealing, of the target substance by heat treatment, and the like.

(2) Filling Micro-Well with Mixed Aqueous Solution

Subsequently, as shown in FIG. 3, a mixed aqueous solution L containing a detection reagent L1 is injected from the inlet 121 into the internal space S. The injection of the mixed aqueous solution L may be carried out using a syringe A. At this time, by inserting the syringe A into the guide hole 151h, alignment of the syringe A with respect to the inlet 121 becomes easy.

In a case where the mixed aqueous solution L flows in the internal space S, namely, the flow channel FC, the micro-well 110 opening in the internal space S is also filled with the mixed aqueous solution L.

At this time, it is preferable to adjust a concentration of the mixed aqueous solution L in advance so that the inside of one micro-well 110 is filled with one target substance. For example, in a case where there is a result that quantification of the target substance is difficult due to a high concentration of the mixed aqueous solution L after carrying out the sample detection method described later, the result is used as a preliminary experimental result, and the mixed aqueous solution Lis diluted. A density of the mixed aqueous solution L of which concentration is adjusted in this way can be approximately close to 1 g/cm³. Therefore, the sealing liquid L2, which is a liquid having a higher density than water, can be determined as a liquid having a higher density than the mixed aqueous solution L.

By the above operation, one micro-well 110 is filled with one or less, that is, 0 or 1 target substance. With this, the number of micro-wells 110 in which the detection reaction described later was confirmed corresponds to the number of the target substances so that detection of the target substances can be carried out in one unit, that is, digital measurement is possible. The target substance does not need to be introduced into all micro-wells 110.

Methods for introducing the target substance into the micro-wells 110 is not particularly limited, and appropriate methods can be selected according to the target substance to be detected. Examples thereof include a method in which the target substance is settled in the device main body 10, in other words, in the flow channel FC by the own weight and distributed into micro-wells.

In addition, by binding the target substance to a substance that traps the target substance, which is also referred to as a trapping substance, the target substance that is difficult to be settled by the own weight may be fed into the device main body 10. In addition, it is possible to improve the efficiency of introducing the target substance into the micro-wells 110 by fixing the capture substance in advance on the micro-wells and capturing the target substance fed together with the mixed aqueous solution L into the capture substance.

The reaction of binding the capture substance and the target substance can be carried out at any time point. For example, the reaction may be carried out by bringing the target substance and the capture substance into contact with each other in the sample tube before adjusting the mixed aqueous solution.

Alternatively, after introducing the capture substance into the micro-well 110, the target substance may be introduced into the micro-well 110 and the capture substance and the target substance may be brought into contact with each other in the micro-well 110.

The capture substance is a substance capable of capturing the target substance. The capture substance may be, for example, a binding body of a solid phase and a specific binding substance to the target substance.

Examples of the solid phase constituting the capture substance may include particles, films, substrates, and the like. In addition, the specific binding substance to the target substance may be one kind or two or more kinds. For example, the specific binding substance to the target substance may be three kinds, may be four kinds, or may be five or more kinds.

The particle is not particularly limited, and examples thereof include a polymer particle, a magnetic particle, a glass particle, and the like. The particle is preferably a particle subjected to a surface treatment to avoid non-specific adsorption. In addition, in order to fix the specific binding substance, a particle having a functional group such as a carboxyl group on the surface is preferable. More specifically, product name “Magnosphere LC300” manufactured by JSR Corporation and the like can be used.

In addition, for example, in a case where a virus is used as the target substance, a cell to which the virus can adhere (that is, a cell having a virus receptor) may be used as the capture substance.

After the internal space S and all the micro-wells 110 are filled with the mixed aqueous solution L, the mixed aqueous solution L having passed through the flow channel FC is discharged from the outlet 122.

The mixed aqueous solution L discharged from the outlet 122 overflows from an upper end of the discharge port 126 into the space S2, as indicated by the reference sign α. The mixed aqueous solution L that overflows into the space S2 is stored in the space S2 as a waste liquid.

### (3) Sealing Mixed Aqueous Solution in Micro-Well 110

Subsequently, as shown in FIG. 4, the sealing liquid L2 is injected from the inlet 121 into the flow channel FC. The injection of the sealing liquid L2 may also be carried out using the syringe A in the same manner as the injection of the mixed aqueous solution L.

The sealing liquid L2 fed to the flow channel FC flows in a surface direction of an upper surface 11a in the internal space S, and the mixed aqueous solution L that is not accommodated in the micro-well 110, of the mixed aqueous solution L fed to the flow channel FC is pushed away and substituted. By doing this, the sealing liquid L2 individually seals the plurality of micro-wells 110 accommodating the mixed aqueous solution L containing the target substance, and the micro-wells 110 become independent reaction spaces.

When the sealing liquid L2 is injected, the sealing liquid L2 may be slowly injected so that the sealing liquid L2 does not contain air bubbles in the internal space S. After the injection of the sealing liquid L2, it is visually confirmed that the sealing liquid L2 does not contain air bubbles by the injection.

At this time, the used sealing liquid L2 is preferably a sealing liquid L2 included in the above-described detection kit 100, in particular, fluorine-based oil.

In a case where the flow channel FC is filled with the sealing liquid L2, excess sealing liquid L2 is discharged from the outlet 122. The sealing liquid L2 discharged from the outlet 122 overflows from the upper end of the discharge port 126 into the space S2. The sealing liquid L2 that overflows into the space S2 is stored in the space S2 as a waste liquid.

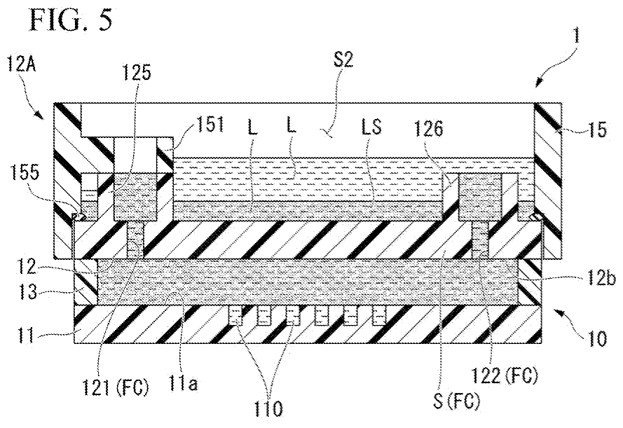

At this time, as shown in FIG. 5, in the space S2, the mixed aqueous solution L which is aqueous and the sealing liquid L2 which is oily are separated into two layers. In addition, since the sealing liquid L2 has a higher density than the mixed aqueous solution L, the sealing liquid L2 is positioned on a lower layer side in the space S2.

As shown in FIG. 5, in this step, the sealing liquid L2 in a liquid amount in which a liquid surface LS of the sealing liquid L2 discharged in the space S2 surrounded by the lid main body 12 and the adapter 15, namely, wall portion is positioned lower than the upper end of the injection port 125 and the discharge port 126 is introduced into the fluid device 1 to substitute the internal space S. By doing this, the mixed aqueous solution L different from the sealing liquid L2 filled in the internal space S is in contact with an upper end 126a of the discharge port 126, and an interface between the mixed aqueous solution L of the waste liquid and the sealing liquid L2 in the discharge port 126 is formed at a height position of the upper end 126a. In addition, in the space S2, the interface between the mixed aqueous solution L of the waste liquid and the sealing liquid L2 is formed at a position lower than the upper end of the injection port 125 and the upper end of the discharge port 126.

In the space S2, in order for the interface between the mixed aqueous solution L of the waste liquid and the sealing liquid L2 to be formed at the height position described above, the liquid amount of the sealing liquid L2 injected to substitute the internal space S can be controlled by adjustment. The liquid amount as a guideline can be roughly estimated from a volume of the internal space S and a volume of the space S2 of the adapter 15.

### (4) And (5) Heating Device Main Body and Detecting Target Substance

Subsequently, the device main body 10 of the fluid device 1 is heated to cause a reaction between the target substance and the detection reagent L1. At this time, the upper end of the adapter 15, namely, wall portion may be airtightly closed with the lid 20, and then the detection reagent L1 may be reacted.

As a method for detecting a target substance, it is possible to use any known detection method according to the characteristics of the target substance to be detected. For example, first, the method for detecting a target substance can be carried out by carrying out reaction of amplifying a target substance-derived signal at a detectable level, which is also referred to as a signal amplification reaction, depending on the necessity, and then detecting the amplified signal using appropriate means.

Examples of the signal that can be used in the detection method according to the present embodiment may include fluorescence, chemiluminescence, color development, potential change, pH change, and the like.

The signal amplification reaction may be, for example, a biochemical reaction, and more particularly an enzymatic reaction. As an example, the signal amplification reaction is an isothermal reaction in which a fluid device is maintained in a state in which a sample solution including an enzyme for signal amplification is accommodated in the well, under constant temperature conditions with which a desired enzyme activity is obtained, for example, at 60° C. or higher, preferably at about 66° C., for a predetermined time, for example, at least 10 minutes, preferably for about 15 minutes.

In a case where a reaction of detecting a nucleic acid is used, specific examples of the signal amplification reaction include an ICA reaction such as an Invader (registered trademark) method, a LAMP (registered trademark) method, a TaqMan (registered trademark) method, a fluorescent probe method, and the like.

As the signal amplification reaction, the ICA reaction is particularly preferably used. In the ICA reaction, signal amplification proceeds through a cycle of two reactions of (1) complementary binding between nucleic acids and (2) recognition and cleavage of a triple-stranded structure by an enzyme. In such a signal amplification reaction, the influence of reaction cycle inhibition by contaminants other than the target substance is small. Therefore, even in a case where various components other than the target substance, which are also referred to as contaminants, are present in the micro-wells 110, the target substance can be detected with high accuracy by using the ICA reaction.

For example, in a case where the ICA reaction is used for the signal amplification reaction, the mixed aqueous solution L contains reaction reagents and template nucleic acid required for the ICA reaction. In a case where the biochemical reaction in the reaction step is an ICA reaction, by an enzymatic reaction due to an isothermal reaction, and in a case where a target substance is present in the well, by the fluorescent substance being released from a quenching substance, a predetermined fluorescent signal is emitted corresponding to an excitation light.

In a case where the ICA reaction is used for the signal amplification reaction, a temperature of the reaction between the target substance and the detection reagent is preferably 50° C. or higher and 99° ° C. or lower.

Hereinafter, the ICA reaction will be described in more detail.

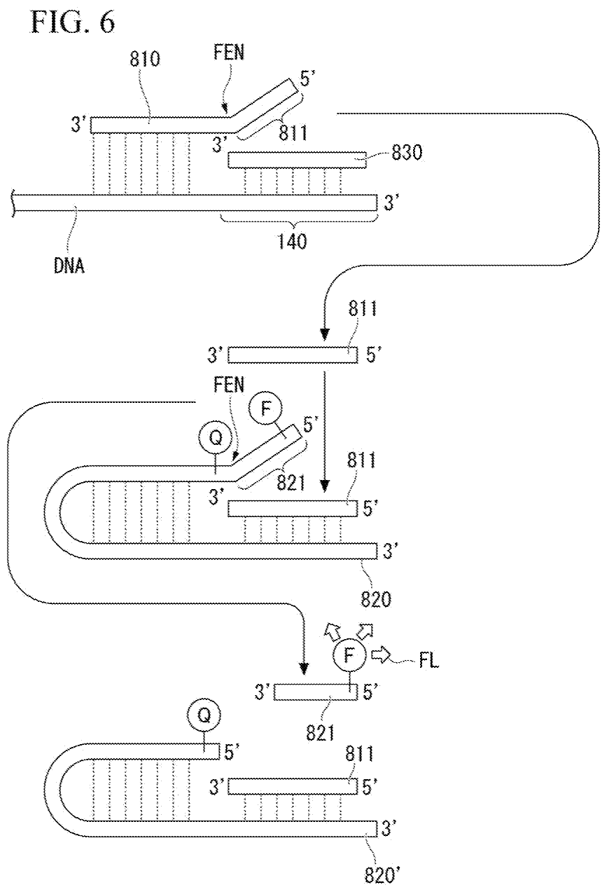

FIG. 6 is a schematic view showing an example of the ICA method. FIG. 6 shows an aspect in which a DNA serving as a target substance is detected by an ICA method.

Examples of reaction reagents necessary for the ICA reaction include ICA reaction reagents such as a flap probe 810, a flap endonuclease FEN, a fluorescent substrate 820, an invasion probe 830, which is also referred to as an invader oligo 830, and the like.

The flap probe 810 and the invasion probe 830 are nucleic acid fragments which are oligonucleotides designed to hybridize with DNA, namely, target DNA which is a target substance to form a flap structure with a double-stranded nucleic acid 140.

The fluorescent substrate 820 is a nucleic acid fragment that has a hairpin structure and in which a fluorescent substance F and a quenching substance Q are bound to each other. In the fluorescent substrate 820 shown in FIG. 6, the fluorescent substance F is bound to a 5′ terminal of the nucleic acid fragment, and the quenching substance Q is bound to several bases 3′ side from the 5′ terminal. The quenching substance Q suppresses the luminescence of the fluorescent substance F.

First, the flap probe 810 and the invasion probe 830 are hybridized to a target DNA. The flap probe 810 and the invasion probe 830 overlap each other by one base at an SNP site of the target DNA, and form an unstable tribasic structure. As a result, a first flap site 811 is formed. The first flap site 811 is a portion of the flap probe 810 that does not hybridize with the target DNA.

Subsequently, FEN recognizes the tribasic structure and reacts therewith. As a result, the first flap site 811 is cleaved to generate the nucleic acid fragment 811, and the nucleic acid fragment 811 is released into the mixed aqueous solution L.

The resulting nucleic acid fragment 811 hybridizes to the fluorescent substrate 820. The nucleic acid fragment 811 invades into the hairpin structure of the fluorescent substrate 820 and overlaps with one base at the SNP site to form an unstable tribasic structure. As a result, a second flap site 821 is formed. The second flap site 821 is a portion of the fluorescent substrate 820 that does not hybridize due to the invasion of the nucleic acid fragment 811.

Subsequently, FEN recognizes the tribasic structure and reacts therewith. As a result, the second flap site 821 is cleaved and the nucleic acid fragment 821 is generated. In FIG. 6, the remaining portion obtained by cleaving the nucleic acid fragment 821 from the fluorescent substrate 820 is indicated by reference numeral 820′.

As a result, the fluorescent substance F is separated from the quenching substance Q, and a fluorescence FL is generated. The target DNA can be detected by detecting this fluorescence FL.

In addition, the detection of the target substance can be carried out by binding a substance that specifically binds to the target substance, namely, specific binding substance to the target substance and detecting the bound specific binding substance. For example, in a case where the target substance is a protein, the protein can be detected using ELISA. More specifically, the detection may be carried out by, for example, sandwich ELISA using the FRET principle.

In a case of carrying out the sandwich method using the FRET principle, first, a first specific binding substance (for example, antibody) labeled with the first fluorescent substance which is also referred to as a donor and a second specific binding substance labeled with the second fluorescent substance which is also referred to as an acceptor having an adsorption wavelength overlapping the fluorescence wavelength of the first fluorescent substance are prepared.

Subsequently, the target substance (for example, antigen) is brought into contact with both of the first specific binding substance and the second specific binding substance to form a composite body. In a case where a composite body is formed, a distance between the donor and the acceptor is reduced, and thus the fluorescence wavelength of the acceptor can be detected by irradiation with the excitation wavelength of the donor. Alternatively, the specific binding substance may be labeled with a nucleic acid fragment, and the nucleic acid fragment may be detected by the ICA reaction.

As the specific binding substance, the same specific binding molecule as the specific binding molecule for a structural body described later, for example, an antibody, an antibody fragment, an aptamer, and the like can be used. In order to detect a specific binding substance bound to a target substance, the specific binding substance may be directly or indirectly labeled with an enzyme such as horseradish peroxidase (HRP), for example. In a case where two or more specific binding substances are used, each of the specific binding molecules can be identifiably labeled from one another.

As a signal observation method, a known appropriate method can be selected depending on the type of the signal to be observed. For example, in a case of carrying out bright field observation, the base material on which a well array is provided is irradiated with white light in a vertical direction. In a case where a fluorescent signal is observed, the inside of the well is irradiated with excitation light corresponding to the fluorescent substance from a bottom side of the well, and the fluorescence emitted by the fluorescent substance is observed. An image of the whole or a part of the observed well array is captured and stored, and image processing by a computer system is carried out.

In a case where the fluid device 1 is heated in the above-described detection reaction, a liquid such as mixed aqueous solution L and sealing liquid L2 filled in the internal space S or a waste liquid stored in the space S2 convectively moves. At this time, in a case where the waste liquid moves into the internal space S due to the convection, there is a possibility that the target substance or the reaction reagent stored inside the micro-well 110 also moves, and this hinders accurate evaluation. In addition, in a case where the waste liquid moves into the internal space S, there is a possibility that an unexpected reagent reaction is caused due to an increase or contamination of the background brightness at the time of measurement, and this leads to a reduction in the accuracy of measurement.

On the other hand, as shown in FIG. 5, the upper end 126a of the discharge port 126 is in contact with the mixed aqueous solution L different from the sealing liquid L2 filled in the internal space S. The mixed aqueous solution L and the sealing liquid L2 have different specific gravities and liquid properties and are hardly mixed with each other. Therefore, even when the fluid device 1 is heated and the liquid held by the fluid device 1 is convected, a large flow is unlikely to occur so that the waste liquid in the space S2 flows toward the internal space S, and the internal space S is hardly likely to be contaminated with the waste liquid.

In addition, the fluid device 1 has an upper end of the wall portion at a position higher than the upper end of the discharge port 126 by having the adapter 15, and the space S2 is larger than that compared to a case where the adapter 15 is not present. Therefore, in the fluid device 1, a large amount of waste liquid can be stored without overflowing, and work efficiency can be improved.

In addition, by closing the upper end of the adapter 15 with the lid 20, a space volume of the gas phase becomes a constant amount in the space S2 of the adapter 15. In this case, since the space S2 is decompressed, the waste liquid hardly flows from the space S2 into the internal space S1 of the fluid device 1. In addition, there is no reason for occurrence of circulation and convection in which the waste liquid flows into the internal space S1 from one port (for example, injection port 125) and the sealing liquid L2 and the like are discharged to the space S2 from the other port (for example, discharge port 126). Therefore, by airtightly closing the upper end of the adapter 15 with the lid 20, it is possible to suppress the inflow of the waste liquid from the space S2 into the internal space S1.

According to the fluid device 1 and the detection kit 100 having the above configuration, it is possible to improve detection accuracy. It is possible to provide a method for detecting a target substance that can suppress the generation of noise and realize high detection accuracy.

In addition, according to the sample detection method having the above configuration, it is possible to suppress the generation of noise and carry out biomolecule measurement with high accuracy.

In the present embodiment, a lower end 15y of the adapter 15 is positioned above a lower end of the device main body 10 in a state in which the adapter 15 is fitted into the lid main body 12 of the device main body 10, but the present invention is not limited thereto. In a state in which the adapter 15 is fitted into the lid main body 12, the lower end 15y may be at the same height position as that of the lower end of the device main body 10. By mounting the adapter 15, a center-of-gravity position becomes higher than that in a case where the adapter 15 is not mounted, but as the lower end 15y is at the same height as that of the lower end of the device main body 10, the entire fluid device 1 can also be supported by the adapter 15. With this, it is possible to suppress the overturning of the fluid device 1.

In addition, in the present embodiment, the adapter 15 is fitted from above the lid main body 12, but the present invention is not limited thereto. For example, a configuration in which an opening portion into which the device main body 10 can be inserted is provided in the wall portion of the adapter 15, and the device main body 10 is inserted into the adapter 15 from a side surface through the opening portion may be used.

In addition, in the present embodiment, the fluid device 1 is described as being separated into the device main body 10 and the adapter 15, but the present invention is not limited thereto. The effect of the present invention can be exhibited even when the lid main body 12 of the device main body 10 and the adapter 15 are integrally formed to form a lid member.

As described above, although preferred examples of the embodiments according to the present invention have been described with reference to the accompanying drawings, the present invention is not limited to such examples. The shapes, combinations, or the like of each of constituent members shown in the examples described above are examples, and can be variously changed based on the design, the specification, and the like within a range that does not deviate from the scope of the present invention.

### EXAMPLES

Hereinafter, the present invention will be described with reference to examples, but the present invention is not limited to these examples.

### [Manufacturing of Fluid Device]

A fluid device shown in FIGS. 1 and 2 was prepared by injection molding using cyclic polyolefin (product number “ZEONOR 1020R”, manufactured by ZEON CORPORATION).

A plurality of micro-wells was formed on one surface of a well plate. A thickness of the well plate was 0.6 mm. An opening shape of the micro-well was set to a circular shape. The micro-well had a diameter of 10 μm and a depth of 15 μm. The plurality of micro-wells in a triangular lattice was disposed such that a distance between a center of each micro-well and a center of a micro-well closest to the micro-well is 12 μm, in a region of 6.0 mm×30.0 mm on a substrate, and thereby a well array was formed.

A lid main body was integrally formed with a wall member. By adjusting a height of the wall member to 30 μm, a height of a flow channel (internal space S) was set to 30 μm.

Subsequently, the well plate and the lid main body (wall member) were bonded by laser welding to prepare a device main body.

### [Preparation of Buffer]

An aqueous medium (buffer) to be fed to the fluid device was prepared according to the composition shown in Table 1. Hereinafter, a unit M represents mol/L.

TABLE 1

| Reagent | Final concentration |
|---|---|
| Distilled water | |
| NaCl | 20 mM |
| MgCl₂ | 25 mM |
| Tris pH 8.5 | 50 mM |
| Tween20 | 0.05% |

In addition, the following reagents were used in examples.
Sealing liquid: Fluorine oil (Fluorinert FC-40, manufactured by SIGMA-ALDRICH)
Fluorescent reagent: Fluorescein-5(6)-isothiocyanate (manufactured by SIGMA-ALDRICH)

### Example 1

### Experimental Example 1-1

A buffer having a composition shown in Table 1 was injected into a flow channel of a fluid device. After the injection, the fluorescence observation of the fluid device was carried out through a filter for Alexa Fluor 488 using a fluorescence microscope (all-in-one fluorescence microscope, model number BZ-X810, manufactured by KEYENCE CORPORATION). The observation results were used as results of the background measurement.

Subsequently, a bufferin which a fluorescent pigment was dissolved (pigment concentration 500 mM) as a model of waste liquid in a space S2 of the adapter was filled until an injection port and a discharge port were below a liquid surface. Thereafter, the fluid device was disposed on a heater (aluminum block constant temperature bath, model DTU-Mini, manufactured by TAITEC) that was heated at 66° C. without covering the adapter, and allowed to stand for 25 minutes.

The waste liquid (buffer) in the space S2 was removed, and fluorescence observation was carried out under the above conditions. With this, it was confirmed whether or not the buffer containing the fluorescent pigment disposed in the space S2 flowed backward to the internal space S.

### Experimental Example 1-2

Experimental Example 1-2 was carried out in the same manner as in Experimental Example 1-1 except that a sealing liquid was injected into the flow channel of the fluid device instead of the buffer.

### [Evaluation Results]

As a result of the evaluation, refluxes of the buffer containing the fluorescent pigment were confirmed in Experimental Example 1-1. On the other hand, in Experimental Example 1-2, no fluorescence was observed, and the reflux of the buffer containing the fluorescent pigment could not be confirmed.

### Example 2

### Experimental Example 2-1

A sealing liquid was injected into a flow channel of a fluid device. After the injection, background measurement was carried out.

Subsequently, a space S2 of an adapter was filled with a mixed solution 1 described below. The mixed solution 1 was separated into two layers, in which the upper layer was a buffer and the lower layer was the sealing liquid, in the space S2. Upper ends of an injection port and a discharge port were below a liquid surface of the lower layer, and the sealing liquid in the space S2 and the sealing liquid in the device main body were continuous.

### (Mixed Solution 1)

Buffer containing fluorescent pigment (pigment concentration 500 mM): 0.2 mL
Sealing liquid: 1.3 mL

The fluid device was disposed on a heater heated at 66° C. and allowed to stand for 25 minutes, and then a waste buffer in the space S2 was removed, and fluorescence observation was carried out under the above conditions.

### Experimental Example 2-2

A sealing liquid was injected into a flow channel of a fluid device. After the injection, background measurement was carried out.

Subsequently, the space S2 of the adapter was filled with a mixed solution 2 described below. The mixed solution was separated into two layers, in which the upper layer was the buffer and ethanol and the lower layer was the sealing liquid, in the space S2. Upper ends of the injection port and the discharge port were disposed above the liquid surface of the lower layer, and the sealing liquid in the space S2 and the sealing liquid in the device main body were not continuous.

### (Mixed Solution 2)

Buffer containing fluorescent pigment (pigment concentration 500 mM): 0.6 mL
Sealing liquid: 0.6 mL
70% ethanol: 0.3 mL

The fluid device was disposed on a heater heated at 66° C. and allowed to stand for 25 minutes, and then a waste buffer in the space S2 was removed, and fluorescence observation was carried out under the above conditions.

### Experimental Example 2-3

A sealing liquid was injected into a flow channel of a fluid device. After the injection, background measurement was carried out.

Subsequently, the space S2 of the adapter was filled with a mixed solution 3 described below. The mixed solution 3 was separated into two layers, in which the upper layer was the buffer and the lower layer was the sealing liquid, in the space S2. Upper ends of the injection port and the discharge port were disposed above the liquid surface of the lower layer, and the sealing liquid in the space S2 and the sealing liquid in the device main body were not continuous.

### (Mixed Solution 3)

Buffer containing fluorescent pigment (pigment concentration 500 mM): 0.5 mL
Sealing liquid: 0.6 mL

The fluid device was disposed on a heater heated at 66° C. and allowed to stand for 25 minutes, and then a waste buffer in the space S2 was removed, and fluorescence observation was carried out under the above conditions.

### [Evaluation Results]

As a result of the evaluation, refluxes of the buffer containing the fluorescent pigment were confirmed in Experimental Example 2-1. On the other hand, in Experimental Examples 2-2 and 2-3, no fluorescence was observed, and the reflux of the buffer containing the fluorescent pigment could not be confirmed.

From the above results, it was confirmed that the present invention is useful.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A fluid device comprising:
a substrate including a plurality of wells on one surface; and
a first lid being disposed to face the wells of the substrate,
wherein the first lid comprises:
an inlet that penetrates the first lid in a thickness direction,
an injection tube that communicates with the inlet and extends above the inlet,
an outlet that penetrates the first lid in the thickness direction,
a discharge tube that communicates with the outlet and extends above the outlet, and
an annular wall portion in a plan view provided along a peripheral edge portion of an upper surface of the first lid, and
an upper end of the annular wall portion is higher than upper ends of the injection tube and the discharge tube.

2. The fluid device according to claim 1,
wherein the first lid comprises a lid main body facing the wells, and a wall main body being detachable from the lid main body and configured to form the wall portion by being fitted into the lid main body.

3. The fluid device according to claim 2,
wherein the wall main body comprises a guide portion overlapping the injection tube in the plan view, and
the guide portion comprises a guide hole overlapping the inlet in the plan view.

4. The fluid device according to claim 1, further comprising:
a second lid that is configured to be fitted into the wall portion and airtightly close the upper end of the wall portion.

5. A detection kit comprising:
the fluid device according to claim 1; and
an oily sealing liquid with a higher density than water.

6. A detection kit comprising:
the fluid device according to claim 2; and
an oily sealing liquid with a higher density than water.

7. A detection kit comprising:
the fluid device according to claim 3; and
an oily sealing liquid with a higher density than water.

8. A detection kit comprising:
the fluid device according to claim 4; and
an oily sealing liquid with a higher density than water.

9. A method for detecting a target substance using the fluid device according to claim 1, the method comprising:
preparing a mixed aqueous solution of a detection reagent that reacts with the target substance and a sample including the target substance;
introducing the mixed aqueous solution into an inside the fluid device from the inlet and filling the wells with the mixed aqueous solution;
introducing an oily sealing liquid into the fluid device, discharging a portion of the mixed aqueous solution in the inside of the fluid device from the outlet, and sealing the mixed aqueous solution in the wells by the oily sealing liquid;
heating the fluid device to react the target substance and the detection reagent; and
detecting the target substance,
wherein the oil sealing liquid has a higher density than water, and
in the sealing, the oil sealing liquid is introduced into the fluid device with a liquid amount at which a liquid surface of the mixed aqueous solution discharged into a space surrounded by the first lid and the wall portion is higher than the upper ends of the injection tube and the discharge tube, and a liquid surface of the oil sealing liquid discharged into the space surrounded by the first lid and the wall portion is lower than the upper ends of the injection tube and the discharge tube.

10. A method for detecting a target substance using the fluid device according to claim 2, the method comprising:
preparing a mixed aqueous solution of a detection reagent that reacts with the target substance and a sample including the target substance;
introducing the mixed aqueous solution into an inside the fluid device from the inlet and filling the wells with the mixed aqueous solution;
introducing an oily sealing liquid into the fluid device, discharging a portion of the mixed aqueous solution in the inside of the fluid device from the outlet, and sealing the mixed aqueous solution in the wells by the oily sealing liquid;
heating the fluid device to react the target substance and the detection reagent; and
detecting the target substance,
wherein the oil sealing liquid has a higher density than water, and
in the sealing, the oil sealing liquid is introduced into the fluid device with a liquid amount at which a liquid surface of the mixed aqueous solution discharged into a space surrounded by the first lid and the wall portion is higher than the upper ends of the injection tube and the discharge tube, and a liquid surface of the oil sealing liquid discharged into the space surrounded by the first lid and the wall portion is lower than the upper ends of the injection tube and the discharge tube.

11. A method for detecting a target substance using the fluid device according to claim 3, the method comprising:
preparing a mixed aqueous solution of a detection reagent that reacts with the target substance and a sample including the target substance;
introducing the mixed aqueous solution into an inside the fluid device from the inlet and filling the wells with the mixed aqueous solution;
introducing an oily sealing liquid into the fluid device, discharging a portion of the mixed aqueous solution in the inside of the fluid device from the outlet, and sealing the mixed aqueous solution in the wells by the oily sealing liquid;
heating the fluid device to react the target substance and the detection reagent; and
detecting the target substance,
wherein the oil sealing liquid has a higher density than water, and
in the sealing, the oil sealing liquid is introduced into the fluid device with a liquid amount at which a liquid surface of the mixed aqueous solution discharged into a space surrounded by the first lid and the wall portion is higher than the upper ends of the injection tube and the discharge tube, and a liquid surface of the oil sealing liquid discharged into the space surrounded by the first lid and the wall portion is lower than the upper ends of the injection tube and the discharge tube.

12. A method for detecting a target substance using the fluid device according to claim 4, the method comprising:
preparing a mixed aqueous solution of a detection reagent that reacts with the target substance and a sample including the target substance;
introducing the mixed aqueous solution into an inside the fluid device from the inlet and filling the wells with the mixed aqueous solution;
introducing an oily sealing liquid into the fluid device, discharging a portion of the mixed aqueous solution in the inside of the fluid device from the outlet, and sealing the mixed aqueous solution in the wells by the oily sealing liquid;
heating the fluid device to react the target substance and the detection reagent; and
detecting the target substance,
wherein the oil sealing liquid has a higher density than water, and
in the sealing, the oil sealing liquid is introduced into the fluid device with a liquid amount at which a liquid surface of the mixed aqueous solution discharged into a space surrounded by the first lid and the wall portion is higher than the upper ends of the injection tube and the discharge tube, and a liquid surface of the oil sealing liquid discharged into the space surrounded by the first lid and the wall portion is lower than the upper ends of the injection tube and the discharge tube.
